(19) United States
(12) Patent Application Publication
(10) Pub. No.: US 2025/0266576 A1
(43) Pub. Date: Aug. 21, 2025

(54) FLEXIBLE ELECTRODE ASSEMBLY AND RECHARGEABLE BATTERY INCLUDING THE SAME

(71) Applicant: Samsung SDI Co., Ltd., Yongin-si (KR)

(72) Inventors: Heonhee Kim, Yongin-si (KR); Bo Hyun Kim, Yongin-si (KR); Suha Lee, Yongin-si (KR); Seungyeol Yoo, Yongin-si (KR); Duckhyun Kim, Yongin-si (KR); Woonsuk Jang, Yongin-si (KR)

(73) Assignee: Samsung SDI Co., Ltd., Yongin-si (KR)

(21) Appl. No.: 19/013,889

(22) Filed: Jan. 8, 2025

(30) Foreign Application Priority Data
Feb. 21, 2024 (KR) 10-2024-0025352

(51) Int. Cl. H01M 50/463; H01M 10/04; H01M 50/105; H01M 50/136

(52) U.S. Cl. CPC H01M 50/463; H01M 10/0459; H01M 50/105; H01M 50/136

(57) ABSTRACT

A rechargeable battery according to some embodiments includes a first electrode assembly including a first positive electrode and a first negative electrode disposed with a separator therebetween; and a second electrode assembly including a second positive electrode and a second negative electrode disposed with the separator therebetween. The first positive electrode and the second negative electrode may be alternately arranged in a matrix structure on one surface of the separator, the first negative electrode and the second positive electrode may be alternately arranged in a matrix structure on the other surface of the separator, and the separator may include a bendable bent portion disposed between rows or columns of the matrix structure.

### CROSS-REFERENCE TO RELATED APPLICATIONS

This present application claims priority to and the benefit under 35 U.S.C. § 119(a)-(d) of Korean Patent Application No. 10-2024-0025352, filed on Feb. 21, 2024, in the Korean Intellectual Property Office, the entire disclosure of which is incorporated herein by reference.

### FIELD

The present disclosure relates to a flexible electrode assembly and a rechargeable battery including the same.

### BACKGROUND

Unlike primary batteries, secondary batteries (rechargeable batteries) are repeatedly charged and discharged batteries. Small-capacity rechargeable batteries can be used in small, portable electronic devices, such as mobile phones, laptop computers, and camcorders. High-capacity and high-density rechargeable batteries have been used as power sources for driving motors in hybrid and electric vehicles or for energy storage.

The aforementioned information disclosed in the technology that forms the background of the present disclosure is only intended to improve understanding of the background of the present disclosure, and therefore may include information that does not constitute related art.

### SUMMARY

According to some embodiments, the present disclosure provides an electrode assembly that may be deformed and a rechargeable battery including the same.

However, the technical problems to be solved by the present disclosure are not limited to the problems described herein, and other problems not mentioned may be clearly understood by those skilled in the art from the description of the disclosure described below.

According to some embodiments, a rechargeable battery includes: a first electrode assembly including a first positive electrode and a first negative electrode disposed with a separator therebetween; and a second electrode assembly including a second positive electrode and a second negative electrode disposed with the separator therebetween. The first positive electrode and the second negative electrode may be alternately arranged in a matrix structure on one surface of the separator, the first negative electrode and the second positive electrode may be alternately arranged in a matrix structure on the other surface of the separator, and the separator may include a bendable bent portion disposed between rows or columns of the matrix structure.

The first positive electrode and first negative electrode of the first electrode assembly may be alternately stacked in one direction, the second positive electrode and second negative electrode of the second electrode assembly may be alternately stacked in the one direction, and the first electrode assembly and the second electrode assembly may be separated by the bent portion.

A pivot line for bending or folding the first electrode assembly or the second electrode assembly may be provided at the bent portion.

The rechargeable battery may include one or more additional electrode assemblies.

The separator may have a continuous sheet shape.

The bent portion may include a first bent portion and a second bent portion arranged in a zigzag shape and a third bent portion disposed between the first bent portion and the second bent portion.

One or more openings may be provided in the third bent portion.

A wrinkle portion including a concave portion and a convex portion may be provided in the third bent portion.

A first positive electrode tab connected to the first positive electrode and a second positive electrode tab connected to the second positive electrode may protrude in the same direction, a first negative electrode tab connected to the first negative electrode and a second negative electrode tab connected to the second negative electrode may protrude in the same direction, and protruding directions of the first positive electrode tab and the second positive electrode tab may be opposite to protruding directions of the first negative electrode tab and the second negative electrode tab.

A first positive electrode tab connected to the first positive electrode and a second positive electrode tab connected to the second positive electrode may protrude in the same direction, a first negative electrode tab connected to the first negative electrode and a second negative electrode tab connected to the second negative electrode may protrude in the same direction, and protruding directions of the first positive electrode tab and the second positive electrode tab may be the same as protruding directions of the first negative electrode tab and the second negative electrode tab.

The rechargeable battery may further include: a pouch in which the first electrode assembly and the second electrode assembly are accommodated, wherein the pouch may include a foldable region bendable between rows or columns of the matrix structure to be a folded region.

The pouch may further include: a first electrode assembly accommodating portion accommodating the first electrode assembly; and a second electrode assembly accommodating portion accommodating the second electrode assembly, and the first electrode assembly accommodating portion and the second electrode assembly accommodating portion may be connected by the folded region

The bent portion may include first and second bent portions arranged in a zigzag shape; and a third bent portion disposed between the first bent portion and the second bent portion, wherein the third bent portion and the folded region may be thermally compressed.

According to other embodiments, a rechargeable battery includes: a separator including a first bent portion, a second bent portion, a third bent portion disposed between the first bent portion and the second bent portion, a plurality of first separation portions connected to the first bent portion and the third bent portion, and a plurality of second separation portions connected to the second bent portion and the third bent portion, wherein a first positive electrode and a first negative electrode of a first electrode assembly are separately disposed between the plurality of first separation portions, a second positive electrode and a second negative electrode of a second electrode assembly are separately disposed between the plurality of second separation portions, the first bent portion is connected to one side of the first separation portion and has a bent shape so that the first positive electrode or the first negative electrode is surrounded by the first separation portion, the second bent portion is connected to one side of the second separation portion and has a bent shape so that the second positive electrode or the second negative electrode is surrounded by the second separation portion, and the third bent portion is connected to the other side disposed opposite to the one side of the first separation portion and to the other side disposed opposite to the one side of the second separation portion.

According to other embodiments, a method of manufacturing a rechargeable battery includes: alternately disposing a first electrode of each of the different electrode assemblies in a matrix structure on one surface of a continuous sheet-shaped separator; bending the continuous sheet-shaped separator in a direction of wrapping each first electrode to cover each first electrode with the separator; alternately disposing a second electrode of each of the different assemblies at each first electrode on the other surface of the continuous sheet-shaped separator; bending the continuous sheet-shaped separator in a direction covering each second electrode to cover each second electrode with the continuous sheet-shaped separator; and pressing the continuous sheet-shaped separator so that the different electrode assemblies are stacked by bent portions formed between rows or columns of the matrix structure.

According to some embodiments of the present disclosure, since the separator and the pouch include a plurality of bent portions, the flexible electrode assembly that may be stacked in various shapes and the rechargeable battery including the same may be provided.

According to some embodiments of the present disclosure, the electrode assembly and the rechargeable battery including the same may be stacked in various forms, so that a rechargeable battery accommodation space in a product may be utilized to the maximum.

According to some embodiments of the present disclosure, the rate of the rechargeable battery manufacturing process may be improved because the existing manufacturing process may be utilized as is.

### BRIEF DESCRIPTION OF THE DRAWINGS

The drawings accompanying this specification illustrate embodiments of the present disclosure and serve to further understand the technical idea of the present disclosure together with the detailed description of the disclosure described below, so the present disclosure should not be construed as being limited to only the matters described in such drawings.

FIG. 1 is a perspective view illustrating a rechargeable battery according to some embodiments of the present disclosure.

FIG. 2 is a partially cross-sectional perspective view taken along line II-II shown in FIG. 1.

FIG. 3A is a perspective view illustrating a stacking process during the rechargeable battery manufacturing process according to some embodiments of the present disclosure.

FIG. 3B is a schematic diagram illustrating a pouch process during the rechargeable battery manufacturing process according to some embodiments of the present disclosure.

FIG. 3C is a schematic diagram illustrating a sealing and pressing process during the rechargeable battery manufacturing process according to some embodiments of the present disclosure.

FIG. 4 is a diagram illustrating the matrix structure of electrodes in at least one embodiment of the present disclosure.

FIG. 5 is a front view illustrating a third bent portion and a folded region in a bent state in the rechargeable battery according to the embodiments of FIGS. 1 to 3.

FIG. 6 is a plan view illustrating an opening formed in the third bent portion and the folded region of a rechargeable battery according to some embodiments of the present disclosure.

FIG. 7A is a plan view illustrating a state in which wrinkles are formed in the third bent portion and folded region of a rechargeable battery according to some embodiments of the present disclosure.

FIG. 7B is a front view illustrating a state in which wrinkles are formed in the third bent portion and folded region of a rechargeable battery according to some embodiments of the present disclosure.

FIG. 8 is a plan view illustrating a state in which a tab of a first electrode and a tab of a second electrode of the rechargeable battery according to some embodiments of the present disclosure are in the same direction.

FIG. 9 is a plan view illustrating a state in which the tab of the first electrode and the tab of the second electrode of the rechargeable battery according to some embodiments of the present disclosure are in the same direction and an opening is formed in the third bent portion.

FIG. 10A is a plan view illustrating a state in which the tab of the first electrode and the second electrode of a rechargeable battery according to some embodiments of the present disclosure are in the same direction and a wrinkle is formed in the third bent portion.

FIG. 10B is a front view illustrating a state in which the tab of the first electrode and the second electrode of a rechargeable battery according to some embodiments of the present disclosure are in the same direction and a wrinkle is formed in the third bent portion.

FIG. 11A is a plan view illustrating a rechargeable battery further including a third electrode assembly as an additional electrode assembly in the rechargeable battery according to the embodiments of FIGS. 1 to 3.

FIG. 11B is a diagram illustrating a state in which the first electrode assembly, the second electrode assembly, and the third electrode assembly of FIG. 11A are stacked.

### DETAILED DESCRIPTION

Hereinafter, embodiments of the present disclosure are described in detail with reference to the accompanying drawings. Prior to this, the terms or words used in this specification and claims should not be construed as being limited to their usual or dictionary meanings, and should be construed as meanings and concepts consistent with the technical idea of the present disclosure based on the principle that the inventor may appropriately define the concept of terms in order to describe his or her invention in the best way. Accordingly, the embodiments described in this specification and the configurations shown in the drawings are only some of the most preferred and/or exemplary embodiments of the present disclosure and do not represent the entire technical idea of the present disclosure. Therefore, it should be understood that there may be various equivalents and variations that may replace them that may exist at the time of filing the present application.

In addition, when used herein, “comprise, include,” and/or “comprising, including” specify the presence of mentioned features, numbers, steps, operations, members, elements, and/or groups thereof and does not exclude the presence or addition of one or more other shapes, numbers, operations, members, elements and/or groups.

In addition, in order to facilitate understanding of the disclosure, the accompanying drawings are not drawn to scale and the dimensions of some components may be exaggerated. In addition, the same components in different embodiments may be given the same reference numbers.

The statement that two objects of comparison are ‘the same’ means that they are ‘substantially the same.’

Therefore, ‘substantially the same’ may include a deviation that is considered low in the art, for example, a deviation less than 5%. In addition, uniformity of a parameter in a certain region may refer to uniformity from an average perspective.

Although first, second, etc. are used to describe various components, these components are of course not limited by these terms. These terms are only used to distinguish one component from another component, and unless specifically stated to the contrary, a first component may also be a second component. In more detail, although the terms first, second, third, etc. may be used herein to describe various elements, components, regions, layers and/or sections, these elements, components, regions, layers and/or sections should not be limited by these terms. This term is used to distinguish one element, component, region, layer, or cross-section from another element, component, region, layer, or cross-section. Accordingly, a first element, component, region, layer, or section discussed below may be named a second element, component, region, layer, or section without departing from the teachings of the example embodiments.

Throughout the specification, unless otherwise stated, each component may be singular or plural.

The arrangement of any component on an “upper portion (or lower portion)” of a component or “above (or below)” a component may refer to not only that any component is disposed in contact with an upper surface (or a lower surface) of the component but also that another component is interposed between the component and any component disposed on (or under) the component.

In addition, when a component is described as “on,” “connected to,” or “coupled to” another component, those components may be directly connected to each other. However, it should be understood that other components may be “interposed” between each component or that each component may be “connected,” “coupled,” or “connected” through other components.

As used herein, the term “and/or” includes any and all combinations of one or more of the associated listed items. In addition, the use of “may” when describing embodiments of the present disclosure relates to “one or more embodiments of the present disclosure.”

Expressions, such as “one or more,” and “one or more” preceding a list of elements, modify the entire list of elements and do not modify individual elements of the list

Throughout the specification, when referring to “A and/or B”, it means A, B, or A and B, unless specifically stated to the contrary, and when referring to “C to D”, it means that it is C or more and D or less unless specifically stated to the contrary.

When a phrase, such as “at least one of A, B and C”, “at least one of A, B or C”, “at least one selected from the group consisting of A, B and C” and “at least one selected from A, B and C” is used to specify a list of elements A, B, and C, the phrase may refer to any and all suitable combinations.

The term “use” may be considered to be synonymous with the term “utilize.”

As used herein, the terms “substantially,” “about,” and similar terms are used as terms of approximation rather than terms of degree and are to consider inherent variations in measured or calculated values as would be recognized by a person of ordinary skill in the art.

For ease of description, spatial relative terms “beneath,” “below,” “lower,” “above,” “upper,” etc. are used to describe the relationship of one element or feature to another element(s) or feature(s) as shown in the drawings. The spatially relative position will be understood to encompass different directions of a device in use or operation in addition to the direction depicted in the figures. For example, if a device in the drawing is turned over, elements described as located “below” or “in a lower portion of” other elements are understood to be “above” or “in an upper portion of” other elements. Therefore, the term “below” may encompass both upward and downward directions.

The terms used in this specification are for describing embodiments of the present disclosure and are not intended to limit the disclosure as discussed above.

In recent years, with the rapid expansion of the market for smartphones, tablet PCs, and wearable products, the need for bendable or foldable, that is, flexible, rechargeable batteries has emerged.

The design of electronic devices using rechargeable batteries has also changed in accordance with the preferences of consumers who want a variety of products day by day. Accordingly, there is a need for rechargeable batteries to be designed in accordance with the design of the electronic device to which the rechargeable battery is applied.

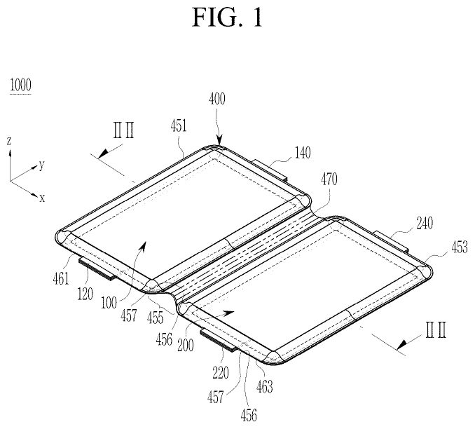

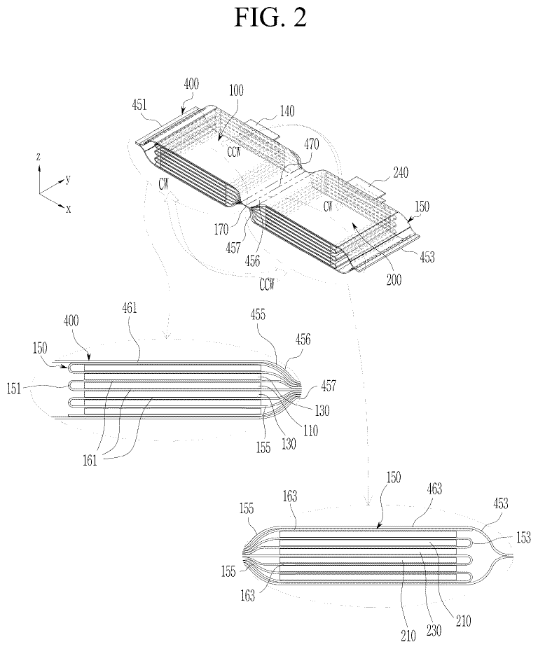

FIG. 1 is a perspective view illustrating a rechargeable battery 1000 according to some embodiments of the present disclosure. FIG. 2 is a cross-sectional view taken along line II II-II II in FIG. 1.

Referring to FIGS. 1 and 2, a rechargeable battery 1000 includes a plurality of electrode assemblies 100 and 200 and a container or pouch 400, hereinafter referred to as a pouch for convenience, accommodating the plurality of electrode assemblies 100 and 200. The rechargeable battery 1000, according to the present embodiments, includes a first electrode assembly 100 and a second electrode assembly 200, that is, two electrode assemblies.

Each electrode assembly 100 or 200 includes at least one first electrode 110 and 210, at least one second electrode 130 and 230, and a separator 150. At least one first electrode 110 and 210 is connected to first electrode tabs 120 and 220, respectively. At least one second electrode 130 and 230 is connected to second electrode tabs 140 and 240, respectively.

The first electrodes 110 and 210 may be a positive electrode or a negative electrode, and the second electrodes 130 and 230 may also be a positive electrode or a negative electrode. The first electrode 110 of the first electrode assembly 100 and the first electrode 210 of the second electrode assembly 200 may be electrodes having the same polarity, and the second electrode 130 of the first electrode assembly 100 and the second electrode 230 of the second electrode assembly 200 may be electrodes having the same polarity.

For example, when the first electrode 110 of the first electrode assembly 100 is a first negative electrode, the first electrode 210 of the second electrode assembly 200 may be a second negative electrode, and when the second electrode 130 of the first electrode assembly 100 is a first positive electrode, the second electrode 230 of the second electrode assembly 200 may be a second positive electrode. When the second electrode 130 of the first electrode assembly 100 is a first negative electrode, the second electrode 230 of the second electrode assembly 200 may be a second negative electrode, and when the first electrode 110 of the first electrode assembly 100 is a first positive electrode, the first electrode 210 of the second electrode assembly 200 may be a second positive electrode.

However, the first electrodes 110 and 210 and the second electrodes 130 and 230 do not have the same polarity. For example, when the first electrodes 110 and 210 are positive electrodes, the second electrodes 130 and 230 may be negative electrodes, and when the first electrodes 110 and 210 are negative electrodes, the second electrodes 130 and 230 may be positive electrodes.

In the x-y-z coordinate axes shown in FIGS. 1 and 2 (the same are applied to other drawings described below), the x-axis may be a major side direction of the rechargeable battery 1000 or a minor side direction of the first electrodes 110 and 210 and the second electrodes 130 and 230. The y-axis may be a direction perpendicular to the x-axis and may be a minor side direction of the rechargeable battery 1000 or a major side direction of the first electrodes 110 and 210 and the second electrodes 130 and 230. Moreover, the y-axis may be a direction in which the electrode tabs 120, 140, 220, and 240 of the first electrode assembly 100 and the second electrode assembly 200 respectively protrude. The z-axis is a direction perpendicular to both the x-axis and the y-axis and may be a width direction of the rechargeable battery 1000, the first electrodes 110 and 210, and the second electrodes 210 and 230.

Both electrode assemblies 100 and 200 may be arranged to be spaced apart on the same plane. For example, the two electrode assemblies 100 and 200 may be arranged side by side on the x-y plane at a certain interval along the x-axis. For example, the positive electrode assemblies 100 and 200 may be arranged in a matrix structure on the x-y plane. In the present embodiments, the positive electrode assemblies 100 and 200 may be arranged in a 1×2 matrix structure on the x-y plane.

As shown in FIG. 2, the first electrode 110 and the second electrode 130 of the first electrode assembly 100 are alternately stacked in the z-axis direction. That is, the first electrode 110 and the second electrode 130 of the first electrode assembly 100 are alternately stacked. The first electrode 210 and the second electrode 230 of the second electrode assembly 200 may also be stacked in the same manner. However, the first electrode 210 and the second electrode 230 of the second electrode assembly 200 may alternate with the first electrode 110 and the second electrode 130 of the first electrode assembly 100 in a stacking order.

For example, when the first electrode 110 is disposed at the top of the first electrode assembly 100 based on FIGS. 1 and 2, the first electrode tab 120 of the first electrode 110 protrudes in the −y axis direction (forward direction based on FIG. 1), and the second electrode 230 is disposed at the top of the second electrode assembly 200, so that the second electrode tab 240 of the second electrode 230 protrudes in the +y axis direction (rearward direction based on FIG. 1). Here, the protruding directions of the first electrode tab 120 and the second electrode tab 240 may be the same. That is, in the rechargeable battery according to the present disclosure, the protruding directions of the electrode tab(s) of the first electrode(s) and the electrode tab(s) of the second electrode(s) are not limited.

The pouch 400 includes a first tip portion 451, a second tip portion 453, a folded region 455, and a plurality of accommodating portions 461 and 463. A first electrode assembly accommodating portion 461 and a second electrode assembly accommodating portion 463 are respectively accommodated in the plurality of accommodating portions 461 and 463. The accommodating portions included in the pouch 400 are not limited thereto and may further include a third electrode assembly accommodating portion (not shown).

The first electrode assembly accommodating portion 461 may be arranged in a matrix structure together with the second electrode assembly accommodating portion 463. For example, the first electrode assembly accommodating portion 461 and the second electrode assembly accommodating portion 463 may be arranged in a 1×2 matrix structure.

The first tip portion 451 is disposed on one side of the first electrode assembly accommodating portion 461, and the folded region 455 is disposed on the other side of the first electrode assembly accommodating portion 461. In addition, the second tip portion 453 is disposed on one side of the second electrode assembly accommodating portion 463, and the folded region 455 is disposed on the other side. Due to this, the first electrode assembly accommodating portion 461 and the second electrode assembly accommodating portion 463 may be connected by the folded region 455.

The first tip portion 451 and the second tip portion 453 may be located in directions facing each other. For example, the first tip portion 451 and the second tip portion 453 may be located in opposite directions with the folded region 455 interposed therebetween along the x-axis.

The folded region 455 may be located between the first electrode assembly accommodating portion 461 and the second electrode assembly accommodating portion 463. For example, the folded region 455 may be located between the first electrode assembly accommodating portion 461 and the second electrode assembly accommodating portion 463 arranged in the 1×2 matrix structure. In other words, the folded region 455 may be located between columns in the 1×2 matrix structure. The folded region 455 may be bendable between rows or columns of the matrix structure.

The folded region 455 is formed so that the first electrode assembly accommodating portion 461 and the first electrode assembly 100 accommodated therein or the second electrode assembly accommodating portion 463 and the second electrode assembly 200 accommodated therein are rotated clockwise (CW) or rotated counterclockwise (CCW) to be bent or folded. For example, in the electrode assembly having a 1×2 matrix structure, as a portion between the columns is bent, the first electrode assembly accommodating portion 461 and the first electrode assembly 100 accommodated therein or the second electrode assembly accommodating portion 463 and the second electrode assembly 200 accommodated therein may be bent or folded clockwise (CW) or counterclockwise (CCW).

A first surface 456 and a second surface 457 of the pouch 400 disposed in the folded region 455 may be spaced apart or bonded to each other in the z-axis direction. The separator 150 may be located between the first surface 456 and the second surface 457. For example, a third bent portion 155, which is one of the bent portions included in the separator 150, may be located between the first surface 456 and the second surface 457. The bent portion of the separator 150 is described below.

The first surface 456 and the second surface 457 may be concave in a direction perpendicular to the plane where the two electrode assemblies 100 and 200 are disposed. For example, the second surface 457 may have a concave shape in the +z-axis direction, and the first surface 456 may have a concave shape in the −z-axis direction. In some embodiments, the concave shape includes shapes, such as squares and semicircles, but is not limited thereto. As the first surface 456 and the second surface 457 of the folded region 455 have a concave shape, the first electrode assembly 100 or the second electrode assembly 200 may be bent or folded more easily based on the folded region 455.

The folded region 455 may include a pivot line 470. The pivot line 470 may be formed along the y-axis at a central point including the exact center of the folded region 455. The pivot line 470 may be provided at a folded region 455. For example, the pivot line 470 may be formed along the y-axis at a central point including the exact center between columns of the 1×2 matrix structure. In the present embodiments, the pivot line 470 is provided at the exact center of the folded region 455. Due to the pivot line 470, the first electrode assembly 100 or the second electrode assembly 200 may be bent or folded based on the pivot line 470 as a starting point.

Referring to FIG. 2, the first electrode assembly 100 includes first electrodes 110 and second electrodes 130 that are alternately stacked. For example, the first electrode 110 and the second electrode 130 are alternately stacked. In the present embodiments, the first electrode 110 and the second electrode 130 are alternately stacked in the z-axis direction (up-down direction in FIG. 2). The separator 150 may be interposed between the first electrode 110 and the second electrode 130. This arrangement of the first electrode 110 and the second electrode 130 may also be applied to the second electrode assembly 200. The second electrode 130 of the first electrode assembly 100 may be alternately disposed at the first electrode 110 on the other surface of the separator 150.

The separator 150 may be configured in the shape of a single continuous sheet. Of course, the shape of the separator 150 is not limited thereto. As shown in FIG. 2, the separator 150 includes a plurality of bent portions 151, 153, and 155, a plurality of first electrode assembly separation portions 161, and a plurality of second electrode assembly separation portions 163. The first electrode assembly 100 and second electrode assembly 200 may be separated by a bent portion 155.

The first electrode 110 of the first electrode assembly 100 and the second electrode 230 of the second electrode assembly 200 may be disposed on one surface of the separator 150, and the second electrode 130 of the first electrode assembly 100 and the first electrode 210 of the second electrode assembly 200 may be disposed on the other surface of the separator 150.

For example, the first electrode 110 of the first electrode assembly 100 may be disposed on one surface of the first electrode assembly separation portion 161, and the second electrode 230 of the second electrode assembly 200 may be disposed on one surface of the second electrode assembly separation portion 163. That is, the first electrode 110 and the second electrode 230 may be arranged in a 1×2 matrix structure on one surface of the separator.

In this case, the second electrode 130 of the first electrode assembly 100 may be disposed on the other surface of the first electrode assembly separation portion 161 (the surface facing the one surface), and the first electrode 210 of the second electrode assembly 200 may be disposed on the other surface of the second electrode assembly separation portion 163. That is, the second electrode 130 and the first electrode 210 may be arranged in a 1×2 matrix structure on the other surface of the second electrode assembly separation portion 163.

However, the first electrodes 110 and 210 or the second electrodes 130 and 230 may not be disposed on the other surface of the first electrode assembly separation portion 161 and the second electrode assembly separation portion 163 located at the top or bottom of each of the first electrode assembly 100 and the second electrode assembly 200.

The plurality of bent portions 151, 153, and 155 include a first bent portion 151, a second bent portion 153, and a third bent portion 155. The first bent portion 151 is connected to one side of the first electrode assembly separation portion 161 and to one side of the first electrode assembly separation portion 161 adjacent on the z-axis. Adjacent first electrode assembly separation portions 161 may be connected through the first bent portion 151. The third bent portion 155 is connected to the other side of the first electrode assembly separation portion 161.

The first bent portion 151 may be formed by bending the separator 150 in a direction of wrapping the first electrode 110 interposed between a pair of adjacent first electrode assembly separation portions 161 on the z-axis in the rechargeable battery 1000 stacking process to be described below. A shape of the first bent portion 151 may be a curved surface (e.g., C shape) or a non-curved surface (e.g., [ shape), but the shape of the first bent portion 151 is not limited thereto. In the present embodiments, the first bent portion 151 is described as being bent in a direction of wrapping the first electrode 110, but it is not limited thereto and may wrap the second electrode 130. The electrodes 110, 130 may be surrounded by the first bent portion 151.

The second electrode assembly 200 also includes the first electrodes 210 and the second electrodes 230 that are alternately stacked. For example, the first electrode 210 and the second electrode 230 are alternately stacked in the z-direction. The second bent portion 153 is connected to one side of the second electrode assembly separation portion 163, and the third bent portion 155 is connected to the other side of the second electrode assembly separation portion 163.

The second bent portion 153 is connected to one side of one second electrode assembly separation portion 163 and to one side of the second electrode assembly separation portion 163 adjacent on the z-axis. Accordingly, adjacent first electrode assembly separation portions 163 may be connected through the second bent portion 153.

In the rechargeable battery 1000 stacking process, which will be described below, the second bent portion 153 may also be formed by bending the separator 150 in a direction of wrapping the first electrode 210 interposed between a pair of adjacent second electrode assembly separation portions 163 on the z-axis. The shape of the second bent portion 153 may be a curved surface (e.g., ⊂ shape) or a non-curved surface (e.g., [ shape), but the shape of the second bent portion 153 is not limited thereto. In the present embodiments, the second bent portion 153 is described as being bent in the direction wrapping the first electrode 210, but the second bent portion 153 is not limited thereto and may wrap the second electrode 230.

However, in some embodiments, when the first bent portion 151 is formed to be bent in a direction of wrapping the first electrode 110, the second bent portion 153 is also formed to be bent only in a direction of wrapping the first electrode 210. Meanwhile, when the first bent portion 151 is formed to be bent in the direction of wrapping the second electrode 130, the second bent portion 153 is also formed to be bent only in the direction of wrapping the second electrode 230.

The first bent portion 151 and the second bent portion 153 are formed along the y-axis direction (forward and backward directions based on FIG. 2) and are located in opposite directions with respect to the y-axis with the third bent portion 155 therebetween. The first bent portion 151 and the second bent portion 153 do not exist on the same plane. The so-called first bent portion 151 and the second bent portion 153 may be arranged in a zigzag shape.

The third bent portion 155 may be located between the first electrode assembly separation portion 161 and the second electrode assembly separation portion 163. Specifically, the third bent portion 155 may be located between columns in a 1×2 matrix structure.

The third bent portion 155 may have a concave shape in a direction perpendicular to the plane where the two electrode assemblies 100 and 200 are disposed. For example, the third bent portion 155 may have a concave shape in the +z-axis or −z-axis direction. In other words, the third bent portion 155 may have a concave shape to correspond to the shapes of the first surface 456 and the second surface 457 of the pouch 400 having a concave shape. Due to this, the third bent portion 155 may be accommodated between the first surface 456 and the second surface 457 of the pouch 400.

The plurality of third bent portions 155 may overlap each other or may be partially in close contact with each other to be accommodated in a space between the first surface 456 and the second surface 457. When the plurality of third bent portions 155 are viewed as a whole, the third bent portions 155 group may have a concave shape in a direction perpendicular to the plane (x-y plane based on FIG. 2) on which both positive electrode assemblies 100 and 200 are disposed.

For example, a portion of the third bent portion 155 close to the first surface 456 of the pouch 400 may have a concave shape in the +z-axis direction and another portion of the third bent portion 155 may have a concave shape in the −z-axis direction. In some embodiments, the concave shape includes a shape, such as a square and semicircle, but is not limited thereto. Since the third bent portion 155 has a concave shape, the first electrode assembly 100 or the second electrode assembly 200 may be bent or folded more easily.

The third bent portion 155 may include a pivot line 170. For example, the pivot line 170 may be formed along the y-axis in the central portion including the exact center of the third bent portion 155. In other words, the pivot line 170 may be formed along the y-axis at a central point including the exact center between columns of a 1×2 matrix structure. In the present embodiments, the pivot line 170 is provided at the exact center of the third bent portion 155. The first electrode assembly 100 or the second electrode assembly 200 may be bent or folded based on the pivot line 170 as a starting point.

Through the third bent portion 155 and the folded region 455 of the aforementioned configuration, the first electrode assembly 100 or the second electrode assembly 200 may rotate clockwise (CW) or counterclockwise (CCW), respectively, based on the pivot lines 170 and 470 within a range of 180 degrees to be bent or folded. For example, the first electrode assembly 100 or the second electrode assembly 200 may rotate in the direction of the arrow shown in FIG. 2 with respect to the pivot lines 170 and 470, that is, clockwise (CW) or counterclockwise (CCW).

For example, when the second electrode assembly 200 rotates counterclockwise (CCW), the second electrode assembly 200 is stacked on the first electrode assembly 100, and the third bent portion 155 and the pivot line 170 are located in the +x direction (rightward direction based on FIG. 2) based on both electrode assemblies 100 and 200. In addition, when the first electrode assembly 100 rotates counterclockwise (CCW), the second electrode assembly 200 is stacked on the first electrode assembly 100, and the third bent portion 155 and the pivot line 170 is located in the −x direction (leftward direction based on FIG. 2) based on both electrode assemblies 100 and 200.

When the second electrode assembly 200 rotates clockwise (CW), the first electrode assembly 100 is stacked on the second electrode assembly 200, and the third bent portion 155 and the pivot line 170 are located in the +x direction (rightward direction based on FIG. 2) based on both electrode assemblies 100 and 200. In addition, when the first electrode assembly 100 rotates clockwise (CW), the first electrode assembly 100 is stacked on the second electrode assembly 200, and the third bent portion 155 and the pivot line 170 are located in the −x direction (leftward direction based on FIG. 2) based on both electrode assemblies 100 and 200.

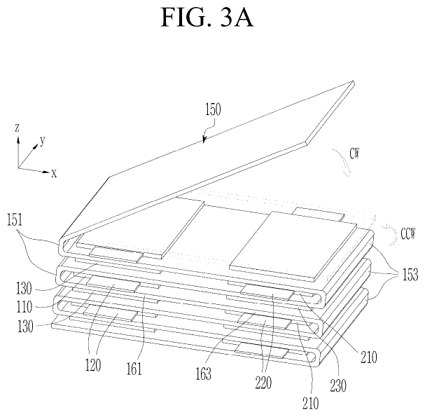

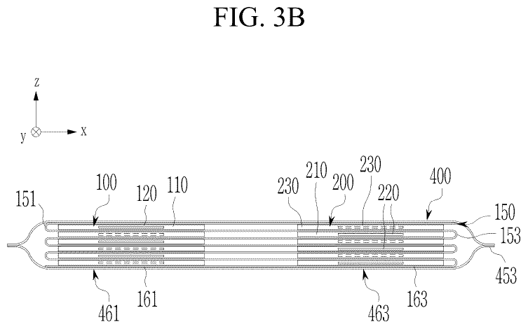

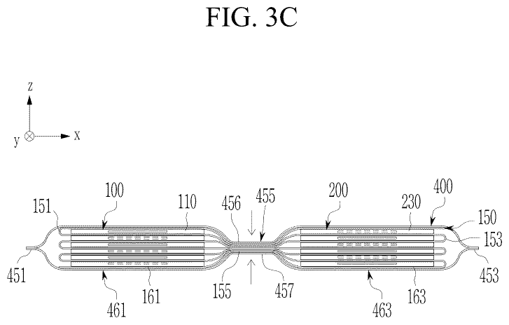

FIGS. 3A to 3C are diagrams illustrating a manufacturing process of the rechargeable battery 1000 according to some embodiments of the present disclosure. FIG. 3A is a perspective view illustrating a stacking process during the manufacturing process of the rechargeable battery 1000 according to some embodiments of the present disclosure. FIG. 3B is a schematic diagram illustrating a pouch process during the manufacturing process of the rechargeable battery 1000 according to some embodiments of the present disclosure. FIG. 3C is a schematic diagram illustrating sealing and pressing processes during the manufacturing process of the rechargeable battery 1000 according to some embodiments of the present disclosure.

Referring to FIG. 3A, the first electrode 110 of the first electrode assembly 100 and the second electrode 230 of the second electrode assembly 200 are disposed on one surface of the first and second electrode assembly separation portions 161 and 163 of the separator 150 alternately in a matrix structure. For example, the first electrode 110 and the second electrode 230 are alternately arranged in a 1×2 matrix structure. On the other surface of the first and second electrode assembly separation portions 161 and 163 of the separator 150, the second electrode 130 of the first electrode assembly 100 and the first electrode 210 of the second electrode assembly 200 are alternately arranged in a matrix structure. For example, the second electrode 130 and the first electrode 210 are alternately arranged in a 1×2 matrix structure.

In a state in which the first electrode 110 of the first electrode assembly 100 and the second electrode 230 of the second electrode assembly 200 are disposed on one surface of the first and second electrode assembly separation portions 161 and 163, the separator 150 may be bent in the direction (CW) of wrapping them (e.g., to cover each electrode 110, 230 with the separator 150). In this case, the first bent portion 151 is formed on one side of the first electrode assembly separation portion 161. In other words, the first bent portion 151 is formed in a direction opposite to the second electrode assembly separation portion 163.

In addition, in a case in which the second electrode 130 of the first electrode assembly 100 and the first electrode 210 of the second electrode assembly 200 are arranged on the other side of the first and second electrode assembly separation portions 161 and 163, when the separator 150 is bent in the direction (CCW) of wrapping them, the second bent portion 153 is formed on one side of the second electrode assembly separation portion 163.

Accordingly, the first bent portion 151 and the second bent portion 153 are disposed in the mutually opposite direction with the first electrode assembly 100 and the second electrode assembly 200 therebetween in the y-axis direction (forward and backward directions with respect to FIG. 2). Here, the first bent portion 151 and the second bent portion 153 do not exist on the same plane.

A section between the first electrode assembly separation portion 161 and the second electrode assembly separation portion 163 may be formed as the third bent portion 155 by a pressing process of FIG. 3C, which will be described below. For example, the third bent portion 155 may be formed between the first electrode 110 and the second electrode 130 of the first electrode assembly 100 and between the first electrode 210 and the second electrode 230 of the second electrode assembly 200. In other words, the third bent portion 155 may be located between columns in a 1×2 matrix structure.

Referring to FIG. 3B, the pouch 400 may wrap both the first electrode assembly 100 and the second electrode assembly 200. Specifically, the pouch 400 may wrap both the upper and lower surfaces of the first electrode assembly 100 and the second electrode assembly 200.

Referring to FIG. 3C, while the first electrode assembly 100 and the second electrode assembly 200 are accommodated in the pouch 400, the pouch 400 may be pressed in a direction in which the pouch 400 is sealed and stacked (z axis based on FIG. 3C). When the pressing process is completed, a corresponding section of the pouch 400 between the first electrode assembly accommodating portion 461 and the second electrode assembly accommodating portion 463 may be formed as the folded region 455. That is, the folded region 455 may be formed between columns in a 1×2 matrix structure. Moreover, by the pressing process, the separator 150 is heat-compressed in the corresponding section of the separator 150 between the first electrode assembly separation portion 161 and the second electrode assembly separation portion 163 to form a third bent portion. It may be formed as third bent portion 155. That is, the third bent portion 155 may be formed between columns in a 1×2 matrix structure. In addition, the pouch portion of the section of the pouch 400 corresponding to the area between the first electrode assembly accommodating portion 461 and the second electrode assembly accommodating portion 463 of the pouch may be thermally compressed to the third bent portion 155 according to the pressing process to be formed as the folded region 455. The third bent portion and folded region may therefore be thermally compressed.

Accordingly, the third bent portion 155 and the folded region 455 may connect the first electrode assembly separation portion 161 and the second electrode assembly separation portion 163 and the first electrode assembly accommodating portion 461 and the second electrode assembly accommodating portion 463, respectively. The first electrode assembly accommodating portion 461 and the first electrode assembly 100 or the second electrode assembly accommodating portion 463 and the second electrode assembly 200 may be folded through the third bent portion 155 and the folded region 455, respectively.

The rechargeable battery 1000 of the embodiments manufactured in this manner may be manufactured using rechargeable battery manufacturing processes and devices of related technology. The rechargeable battery 1000 of the embodiments can stack the electrode assemblies 100, 200 by merely changing the stacking method while using existing equipment.

Accordingly, when manufacturing the rechargeable battery 1000 according to some embodiments of the present disclosure, there is no need to buy new equipment, which can result in cost savings. By placing a plurality of electrodes on each surface of the separator 150, more electrodes can be included in a single electrode assembly compared to conventional stacking methods, thus saving time in producing electrode assemblies of the same capacity.

Therefore, manufacturing costs and time may be saved when manufacturing the rechargeable battery 1000 according to the embodiments.

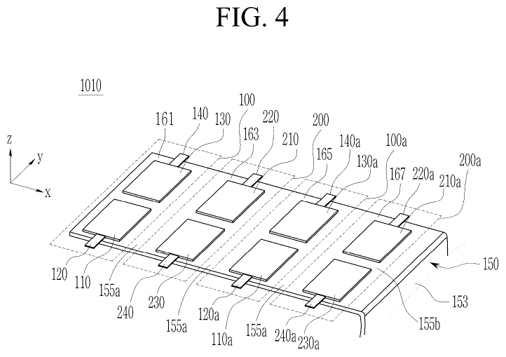

FIG. 4 is a diagram illustrating a matrix structure of electrodes according to some embodiments of the present disclosure.

The matrix structure refers to a structure of at least one first electrode and at least one second electrode being arranged in an m×n matrix. That is, the matrix structure may refer to a structure in which the first electrode and the second electrode are arranged along the same x-axis line to form one row and are arranged along the same y-axis line to form one column.

In addition, the matrix structure refers to a structure in which at least one first electrode and at least one second electrode are alternately arranged at regular intervals. For example, on the same plane, the second electrodes are arranged at regular intervals above and below and/or to the left and right of the first electrodes (up and down in the y-axis direction and left and right in the x-axis direction based on FIG. 4), and the first electrodes are arranged at regular intervals above and below and/or left and right of the second electrodes in the same manner.

FIG. 4 shows an example embodiment of the present disclosure adopting a 2×4 matrix structure. Referring to FIG. 4, a rechargeable battery 1010 includes a first electrode assembly 100, a second electrode assembly 200, a third electrode assembly 100a, and a fourth electrode assembly 200a.

The first electrodes 110, 210, 110a, and 210a and the second electrodes 130, 230, 130a, and 230a of the respective electrode assemblies 100, 200, 100a, and 200a are arranged on one surface of the electrode assembly separation portions 161, 163, 165, and 167 of the separator 150 respectively corresponding to the electrode assemblies 100, 200, 100a, and 200a.

For example, the first electrode 110 and the second electrode 130 of the first electrode assembly 100 are disposed on one surface of the first electrode assembly separation portion 161, the first electrode 210 and the second electrode 230 of the second electrode assembly 200 are disposed on one surface of the second electrode assembly separation portion 163, the first electrode 110a and the second electrode 130a of the third electrode assembly 100a are disposed on one surface of the third electrode assembly separation portion 165, and the first electrode 210a and the second electrode 230a of the fourth electrode assembly 200a are disposed on one surface of the fourth electrode assembly separation portion 167. Here, the positive electrode and negative electrode disposed on one surface of any one of the electrode assembly separation portions 161, 163, 165, and 167 form the same row.

In addition, in the first row of the matrix structure, the first electrode 110 of the first electrode assembly 100, the second electrode 230 of the second electrode assembly 200, the first electrode 110a of the third electrode assembly 100a, and the second electrode 230a of the fourth electrode assembly 200a are disposed, and in the second row of the matrix structure, the second electrode 130 of the first electrode assembly 100, the first electrode 210 of the second electrode assembly 200, the second electrode 130a of the third electrode assembly 100a, and the first electrode 210a of the fourth electrode assembly 200a are disposed.

Here, the tabs of electrodes located in the same row protrude in the same direction. For example, the electrode tabs 120, 240, 120a, and 240a of the electrodes 110, 230, 110a, and 230a located in the first row protrude in the-y-axis direction, and the electrode tabs 140, 220, 140a, and 220a of the electrodes 130, 210, 130a, and 210a located in the second row protrude in the +y-axis direction.

As described above in relation to the embodiments of FIGS. 3A to 3C, the separator 150 may be bent to wrap the electrodes, and electrodes respectively corresponding to the electrode assemblies are arranged on the other surface of the bent separator 150.

The separator 150 includes a plurality of folded regions 155a that may be bent between columns and folded regions 155b that may be bent between rows by the aforementioned sealing and pressing processes. The separator 150 may include a bendable bent portion disposed between rows or columns of the matrix structure. The first electrode assembly 100, the second electrode assembly 200, the third electrode assembly 100a, and the fourth electrode assembly 200a are each rotatable through the plurality of folded regions 155a and 155b. The different electrode assemblies 100, 200 may be stacked by bent portions formed between rows or columns of the matrix structure.

Based on FIG. 4, when the first electrode assembly 100 and the third electrode assembly 100a are considered odd-numbered electrode assemblies, the second electrode assembly 200 and the fourth electrode assembly 200a may be considered even-numbered electrode assemblies.

As described above, when the electrodes of each electrode assembly are disposed on the bent separator 150, the stacking order of the first electrodes 110 and 110a and the second electrodes 130 and 130a of the odd-numbered electrode assemblies 100 and 100a may be the same. In addition, the stacking order of the first electrodes 210 and 210a and the second electrodes 230 and 230a of the even-numbered electrode assemblies 200 and 200a may also be the same.

Meanwhile, the order in which the first electrodes 110 and 110a and the second electrodes 130 and 130a of the odd-numbered electrode assemblies 100 and 100a are stacked may be the opposite to the order in which the first electrodes 210 and 210a and the second electrodes 230 and 230a of the even-numbered electrode assemblies 200 and 200a are stacked.

For example, the stacking order of the first electrode 110a and the second electrode 130a of the third electrode assembly 100a may be the opposite to the stacking order of the first electrode 210 and the second electrode 230 of the second electrode assembly 200 and may also be opposite to the stacking order of the first electrode 210a and the second electrode 230a of the fourth electrode assembly 200a.

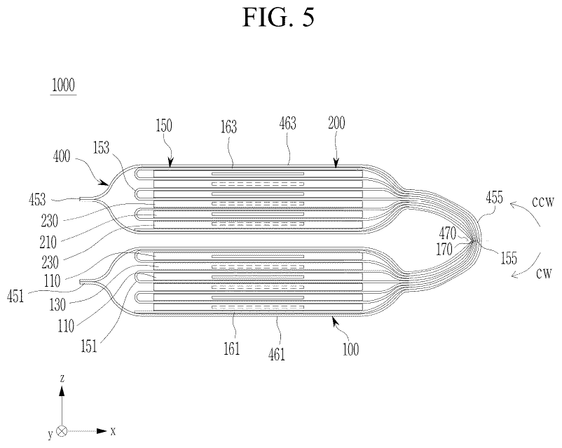

FIG. 5 is a diagram illustrating a state in which the third bent portion 155 and the folded region 455 are bent in the rechargeable battery 1000 according to the embodiments of FIGS. 1 to 3.

Referring to FIG. 5, the third bent portion 155 of the separator 150 and the folded region 455 of the pouch 400 may be bent, and when the third bent portion 155 and the folded region 455 are bent, the first electrode assembly 100 or the second electrode assembly 200 may rotate.

For example, when the second electrode assembly 200 rotates counterclockwise (CCW), the second electrode assembly 200 is stacked on the first electrode assembly 100, and the third bent portion 155 and the pivot lines 170 and 470 are located in the +x direction (rightward direction in FIG. 2) with respect to both electrode assemblies 100 and 200. In addition, when the first electrode assembly 100 rotates counterclockwise (CCW), the second electrode assembly 200 is stacked on the first electrode assembly 100, and the third bent portion 155 and the pivot lines 170 and 470 are located in the −x direction (leftward direction in FIG. 2) with respect to both electrode assemblies 100 and 200.

When the second electrode assembly 200 rotates clockwise (CW), the first electrode assembly 100 is stacked on the second electrode assembly 200, and the third bent portion 155 and the pivot lines 170 and 470 are located in the +x direction (rightward direction in FIG. 2) with respect to both electrode assemblies 100 and 200. In addition, when the first electrode assembly 100 rotates clockwise (CW), the first electrode assembly 100 is stacked on the second electrode assembly 200, and the third bent portion 155 and the pivot lines 170 and 470 are located in the −x direction (leftward direction in FIG. 2) with respect to both electrode assemblies 100 and 200.

Since the third bent portion 155 and the folded region 455 may be bent, the rechargeable battery 1000 according to the present embodiments may be miniaturized and may be configured to be easily inserted into small devices, foldable and bendable devices, etc.

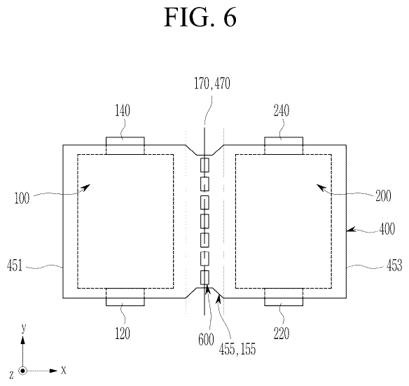

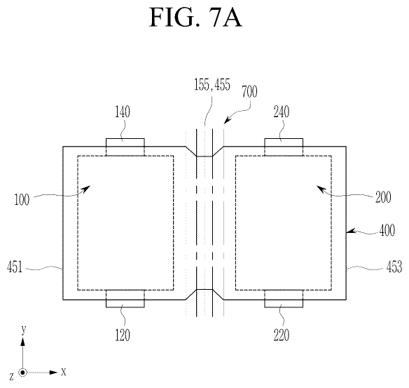

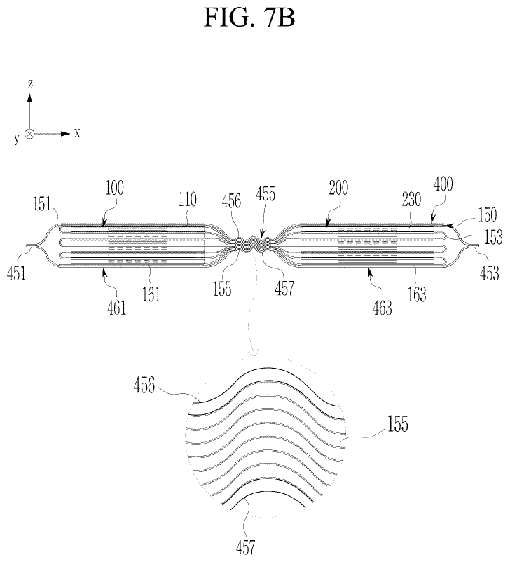

FIG. 6 is a plan view illustrating a state in which an opening 600 is formed in the third bent portion 155 and the folded region 455 of the rechargeable battery 1000 according to some embodiments of the present disclosure. FIG. 7A is a plan view illustrating a state in which a wrinkle portion 700 is formed in the third bent portion 155 and the folded region 455 of the rechargeable battery 1000 according to some embodiments of the present disclosure. FIG. 7B is a front view illustrating the state in which the wrinkle portion 700 is formed in the third bent portion 155 and the folded region 455 of the rechargeable battery 1000 according to some embodiments of the present disclosure.

Referring to FIG. 6, a plurality of openings 600 may be formed in the third bent portion 155 and the folded region 455. For example, the opening 600 may be formed at the pivot line 170 of the third bent portion 155 and the pivot line 470 of the folded region 455. A plurality of openings 600 may be provided at random intervals in the z-axis direction. The shape of the opening 600 can include a circle, square, triangle, etc., and is not limited to a certain shape. When the opening 600 is formed in the third bent portion 155 and the folded region 455, the flexibility of the third bent portion 155 and the folded region 455 may be expanded so that bending of the third bent portion 155 and the folded region 455 may become easier.

Referring to FIGS. 7A and 7B, the wrinkle portion 700 may be formed in the third bent portion 155 and the folded region 455. The wrinkle portion 700 may include a plurality of concave portions and a plurality of convex portions in the z-axis direction. When the wrinkle portion 700 is formed in the third bent portion 155 and the folded region 455, the flexibility of the third bent portion 155 and the folded region 455 may be expanded so that they may be bent more easily.

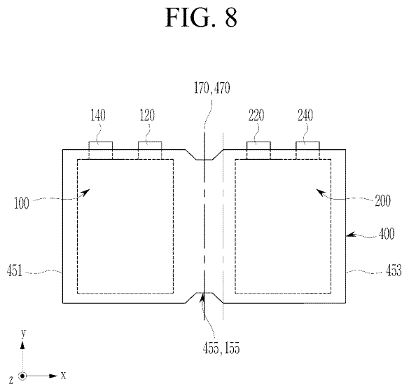

FIG. 8 is a plan view showing a state in which the direction of the tab 120 of the first electrode 110 of the first electrode assembly 100 of the rechargeable battery 1000 according to some embodiments of the present disclosure and the direction of the tab 140 of the second electrode 130 of the first electrode assembly 100 are the same, and the direction of the tab 220 of the first electrode 210 of the second electrode assembly 200 and the direction of the tap 240 of the second electrode 230 of the second electrode assembly 200 are the same.

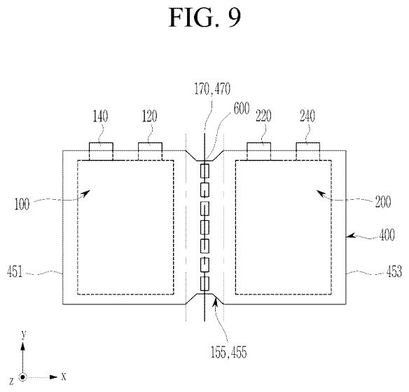

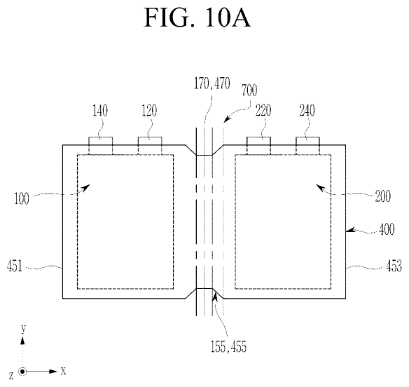

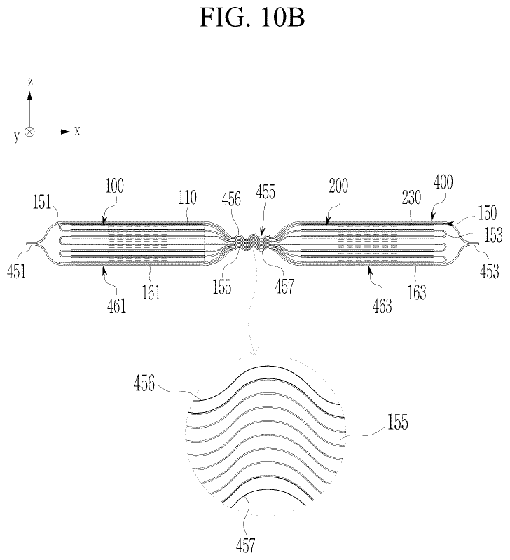

FIG. 9 is a plan view illustrating a state in which the opening 600 is formed in the third bent portion 155 and the folded region 455 of the rechargeable battery 1000 of FIG. 8. FIG. 10A is a plan view illustrating in which the wrinkle portion 700 is adopted in the third bent portion 155 of the separator 150 of the rechargeable battery 1000 of FIG. 8 and the folded region 455. FIG. 10B is a front view illustrating in which the wrinkle portion 700 is adopted in the third bent portion 155 of the separator 150 of the rechargeable battery 1000 of FIG. 8 and the folded region 455.

Referring to FIGS. 8 to 10B, in the rechargeable battery 1000 according to some embodiments of the present disclosure, the tabs 120 and 220 of the first electrodes 110 and 210 and the tabs 140 and 240 of the second electrodes 130 and 230 may be manufactured to have the same direction. At this time, the opening 600 or the wrinkle portion 700 may be provided in the third bent portion 155 and the folded region 455. In this case, due to the expansion of the flexibility of the third bent portion 155 and the folded region 455, the third bent portion 155 and the folded region 455 may be more easily bent or folded. In other embodiments, both the opening 600 and the wrinkle portion 700 may be provided in the third bent portion 155 and the folded region 455.

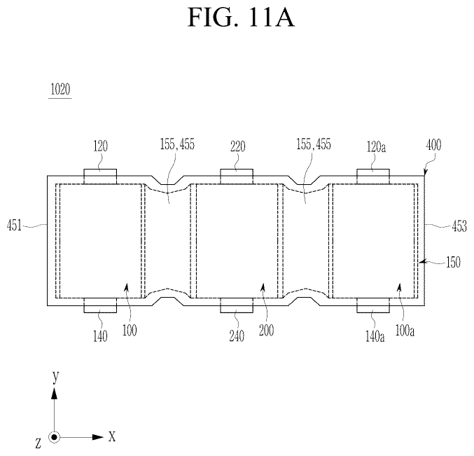

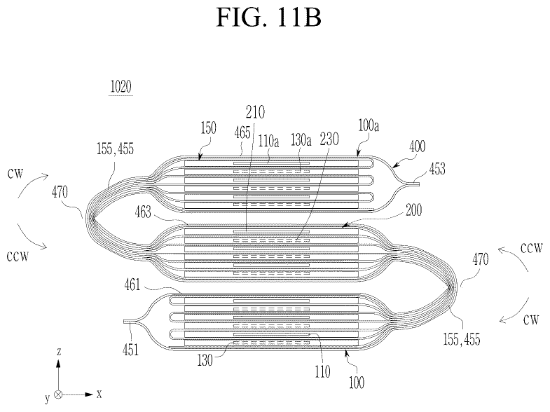

FIG. 11A is a plan view illustrating a rechargeable battery 1020 that further includes a third electrode assembly 100a as an additional electrode assembly in addition to the first electrode assembly 100 and the second electrode assembly 200 of the embodiments of FIGS. 1 to 3. FIG. 11B is a cross-sectional view illustrating a state in which the first electrode assembly 100, the second electrode assembly 200, and the third electrode assembly 100a of FIG. 11A are stacked.

Referring to FIGS. 11A and 11B, the rechargeable battery 1020 includes three electrode assemblies 100, 200, and 100a and a pouch 400 in which the electrode assemblies 100, 200, and 100a are accommodated.

The electrode assemblies 100, 200, and 100a respectively include first electrodes 110, 210, and 110a, second electrodes 130, 230, and 130a, and a separator 150. The first electrodes 110, 210, and 110a are respectively connected to the first electrode tabs 120, 220, and 120a. The second electrodes 130, 230, and 130a are respectively connected to the second electrode tabs 140, 240, and 140a.

The plurality of electrode assemblies 100, 200, and 100a may be arranged to be spaced apart from each other on the same plane. The plurality of electrode assemblies 100, 200, and 100a may be arranged side by side on the x-y plane and spaced apart at a certain distance along the x-axis. For example, the plurality of electrode assemblies 100, 200, and 100a may be arranged in a matrix structure on the x-y plane. In the present embodiments, a plurality of electrode assemblies 100, 200, and 100a may be arranged in a 1×3 matrix structure on the x-y plane.

The pouch 400 may include the first tip portion 451, the second tip portion 453, the folded region 455, and a plurality of accommodating portions 461, 463, and 465. The plurality of accommodating portions 461, 463, and 465 include a first electrode assembly accommodating portion 461, a second electrode assembly accommodating portion 463, and a third electrode assembly accommodating portion 465.

The first tip portion 451 may be connected to one side of the first electrode assembly accommodating portion 461, and the folded region 455 may be connected to the other side of the first electrode assembly accommodating portion 461. The second tip portion 453 may be connected to one side of the third electrode assembly accommodating portion 465, and the folded region 455 may be connected to the other side. The folded region 455 may be connected to both sides of the second electrode assembly accommodating portion 463. That is, the first electrode assembly accommodating portion 461, the second electrode assembly accommodating portion 463, and the third electrode assembly accommodating portion 465 may be connected by the folded region(s) 455.

The folded region 455 may be located between the first electrode assembly accommodating portion 461 and the second electrode assembly accommodating portion 463 and between the second electrode assembly accommodating portion 463 and the third electrode assembly accommodating portion 465. In other words, the folded region 455 may be located between the first electrode assembly accommodating portion 461 and the second electrode assembly accommodating portion 463 and between the second electrode assembly accommodating portion 463 and the third electrode assembly accommodating portion 465 arranged in a 1×3 matrix structure. In other words, the folded region 455 may be located between columns in a 1×3 matrix structure.

The folded region 455 may include the pivot line 470 (see e.g., FIG. 11B). For example, the pivot line 470 may be formed along the y-axis in the central portion including the exact center of the folded region 455. In other words, the pivot line 470 may be formed along the y-axis in the central portion including the exact center between columns of the 1×3 matrix structure. Accordingly, the first electrode assembly 100, the second electrode assembly 200, or the third electrode assembly 100a may be bent or folded based on the pivot line 470 as a starting point.

As the folded region 455 is configured to be bent or folded in this manner, the first electrode assembly accommodating portion 461 and the first electrode assembly 100 accommodated therein, the second electrode assembly accommodating portion 463 and the second electrode assembly 200 accommodated therein, or the third electrode assembly accommodating portion 465 and the third electrode assembly 100a accommodated therein may be folded clockwise (CW) or counterclockwise (CCW).

In other words, as the columns of the 1×3 matrix structure are bent, the first electrode assembly accommodating portion 461 and the first electrode assembly 100 accommodated therein, the second electrode assembly accommodating portion 463 and the second electrode assembly 200 accommodated therein, or the third electrode assembly accommodating portion 465 and the third electrode assembly 100a accommodated therein may be folded clockwise (CW) or counterclockwise (CCW).

For example, when the second electrode assembly 200 rotates counterclockwise (CCW) to be folded, the second electrode assembly 200 is stacked on the first electrode assembly 100, and the third bent portion 155 and the pivot line 470 are located in the +x direction (rightward direction in FIG. 11B) based on both electrode assemblies 100 and 200.

In this state, when the third electrode assembly 100a rotates clockwise (CW) to be folded, the third electrode assembly 100a is stacked on the second electrode assembly 200, and the third bent portion 155 and the pivot line 470 may be located in the −x direction (leftward direction in FIG. 2) based on both electrode assemblies 200 and 100a.

The plurality of electrode assemblies 100, 200, and 100a may be folded in various manners, and the folding direction is not limited thereto. In this manner, when the plurality of electrode assemblies 100, 200, and 100a are stacked in one rechargeable battery cell, a manufacturing rate may be expected to be improved due to simplification of the process and a large amount of energy may be stored in a small volume. That is, the energy density may be increased.

Although it is described that the rechargeable battery includes three electrode assemblies in the depicted embodiment of FIGS. 11A and 11B, the rechargeable battery of the present disclosure is not limited thereto. For example, a rechargeable battery may be configured to include the first electrode assembly 100, the second electrode assembly 200, and the fourth electrode assembly 200a as an additional electrode assembly, and a rechargeable battery may be configured to include the first electrode assembly 100, the second electrode assembly 200 and the third electrode assembly 100a and the fourth electrode assembly 200a as additional electrode assemblies. Of course, a rechargeable battery may be configured by further including additional electrode assemblies. Moreover, the arrangement order of each electrode assembly may be appropriately adjusted for the configuration of a rechargeable battery.

In this manner, when a rechargeable battery is formed by stacking a plurality of electrode assemblies 100, 200, 100a, and 200a, a manufacturing rate may be expected be improved due to simplification of the process and a large amount of energy may be stored in a small volume. That is, the energy density may be increased.

Meanwhile, in some embodiments of the present disclosure, a compound capable of reversible intercalation and deintercalation of lithium (lithiated intercalation compound) may be used as a positive electrode active material constituting a positive electrode active material layer of a positive electrode. For example, one or more types of composite oxides of lithium and a metal selected from cobalt, manganese, nickel, and combinations thereof may be used.

The composite oxide may be a lithium transition metal composite oxide and may include, for example, lithium nickel-based oxide, lithium cobalt-based oxide, lithium manganese-based oxide, lithium iron phosphate-based compound, cobalt-free nickel-manganese-based oxide, or combinations thereof.

As an example, a compound represented by any of the following formulas may be used. LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or combination thereof; X is Al, Ni, Co, Mn, Cr, Fe, Mg, Sr, V, a rare earth element, or combination thereof; D is O, F, S, P, or combination thereof; G is Al, Cr, Mn, Fe, Mg, La, Ce, Sr, V, or combination thereof; and L¹ is Mn, Al, or combination thereof.

The positive electrode according to some embodiments may include a positive electrode current collector in which a positive active material layer is disposed, and the positive active material layer may further include a binder and/or a conductive material.

The content of the positive electrode active material may be 90 wt % to 99.5 wt % based on 100 wt % of the positive electrode active material layer, and the content of the binder and the conductive material may be 0.5 wt % to 5 wt %, respectively, based on 100 wt % of the positive electrode active material layer.

Aluminum (Al) may be used as the positive electrode current collector, but is not limited thereto.

In some embodiments of the present disclosure, a negative electrode active material constituting the negative electrode active material layer of the negative electrode includes a material capable of reversible lithium-ion intercalation/deintercalation, lithium metal, an alloy of lithium metal, a material capable of lithium doping/dedoping, or a transition metal oxide.

The material capable of reversible lithium-ion intercalation/deintercalation may be a carbon-based negative electrode active material and may include, for example, crystalline carbon, amorphous carbon, or combination thereof. Examples of the crystalline carbon include graphite, such as natural graphite or artificial graphite, and examples of the amorphous carbon include soft carbon or hard carbon, mesophase pitch carbide, calcined coke, etc.

A Si-based negative electrode active material or a Sn-based negative electrode active material may be used as the material capable of doping/dedoping lithium. The Si-based negative electrode active material may be silicon, silicon-carbon composite, SiOx (0<x<2), Si-based alloy, or combination thereof.

The silicon-carbon composite may be a composite of silicon and amorphous carbon. According to some embodiments, the silicon-carbon composite may be in the form of silicon particles and amorphous carbon coated on the surface of the silicon particles.

The silicon-carbon composite may further include crystalline carbon. For example, the silicon-carbon composite may include a core including crystalline carbon and silicon particles and an amorphous carbon coating layer located on the surface of the core.

The negative electrode according to some embodiments includes a negative electrode current collector in which the negative electrode active material layer is disposed, and the negative electrode active material layer may further include a binder and/or a conductive material.

For example, the negative electrode active material layer may include 90% to 99 wt % of the negative electrode active material, 0.5% to 5 wt % of the binder, and 0% to 5 wt % of the conductive material.

The binder may be a non-aqueous binder, an aqueous binder, a dry binder, or combination thereof. When an aqueous binder is used as the negative electrode binder, the negative electrode binder may further include a cellulose-based compound capable of imparting viscosity.

The negative electrode current collector may be selected from copper foil, nickel foil, stainless steel foil, titanium foil, nickel foam, copper foam, a polymer substrate coated with a conductive metal, and combination thereof.

The electrolyte solution for a lithium rechargeable battery may include a non-aqueous organic solvent and a lithium salt.

The non-aqueous organic solvent may serve as a medium through which ions involved in an electrochemical reaction of the battery may move.

The non-aqueous organic solvent may be a carbonate-based, ester-based, ether-based, ketone-based, or alcohol-based solvent, an aprotic solvent, or combination thereof, and may be used alone or in a mixture of two or more types.

In addition, in the case of using a carbonate-based solvent, a mixture of cyclic carbonate and chain carbonate may be used.

Depending on the type of lithium rechargeable battery, a separator may exist between the positive and negative electrodes, such as described herein. As the separator, polyethylene, polypropylene, polyvinylidene fluoride, or a multilayer film of two or more layers thereof may be used.

The separator may include a porous substrate and a coating layer including an organic material, an inorganic material, or combination thereof located on one or both sides of the porous substrate.

The organic material may include a polyvinylidene fluoride-based double antibody or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combination thereof, but is not limited thereto.

The organic material and the inorganic material may be mixed in a single coating layer or may exist in a laminated form of a coating layer including an organic material and a coating layer including an inorganic material.

Although the present disclosure has been described with exemplary embodiments and drawings, the present disclosure is not limited thereto, and various modifications and variations may be made by those skilled in the art to which the present disclosure pertains within the scope of equivalence of the patent claims.

What is claimed is:

1. A rechargeable battery comprising:
a first electrode assembly comprising a first positive electrode and a first negative electrode disposed with a separator therebetween; and
a second electrode assembly comprising a second positive electrode and a second negative electrode disposed with the separator therebetween,
wherein the first positive electrode and the second negative electrode are alternately arranged in a matrix structure on one surface of the separator,
the first negative electrode and the second positive electrode are alternately arranged in a matrix structure on the other surface of the separator, and
the separator comprises a bendable bent portion disposed between rows or columns of the matrix structure.

2. The rechargeable battery as claimed in claim 1, wherein:
the first positive electrode and first negative electrode of the first electrode assembly are alternately stacked in one direction,
the second positive electrode and second negative electrode of the second electrode assembly are alternately stacked in the one direction, and
the first electrode assembly and the second electrode assembly are separated by the bendable bent portion.

3. The rechargeable battery as claimed in claim 1, wherein:
a pivot line for bending or folding the first electrode assembly or the second electrode assembly is provided at the bendable bent portion.

4. The rechargeable battery as claimed in claim 1, wherein:
the rechargeable battery comprises one or more additional electrode assemblies.

5. The rechargeable battery as claimed in claim 1, wherein:
the separator has a continuous sheet shape.

6. The rechargeable battery as claimed in claim 5, wherein the bendable bent portion comprises:
a first bent portion and a second bent portion arranged in a zigzag shape; and
a third bent portion disposed between the first bent portion and the second bent portion.

7. The rechargeable battery as claimed in claim 6, wherein:
one or more openings are provided in the third bent portion.

8. The rechargeable battery as claimed in claim 6, wherein:
a wrinkle portion comprising a concave portion and a convex portion is provided in the third bent portion.

9. The rechargeable battery as claimed in claim 1, wherein:
a first positive electrode tab connected to the first positive electrode and a second positive electrode tab connected to the second positive electrode protrude in a same first direction,
a first negative electrode tab connected to the first negative electrode and a second negative electrode tab connected to the second negative electrode protrude in a same second direction, and
the same first direction of the first positive electrode tab and the second positive electrode tab is opposite to the same second direction of the first negative electrode tab and the second negative electrode tab.

10. The rechargeable battery as claimed in claim 1, wherein:
a first positive electrode tab connected to the first positive electrode and a second positive electrode tab connected to the second positive electrode protrude in a same first direction,
a first negative electrode tab connected to the first negative electrode and a second negative electrode tab connected to the second negative electrode protrude in a same second direction, and
the same first direction of the first positive electrode tab and the second positive electrode tab is a same direction as the same second direction of the first negative electrode tab and the second negative electrode tab.

11. The rechargeable battery as claimed in claim 1, further comprising:
a pouch accommodating the first electrode assembly and the second electrode assembly,
wherein the pouch comprises a foldable region that is bendable between rows or columns of the matrix structure to be a folded region.

12. The rechargeable battery as claimed in claim 11, wherein:
the pouch further comprises:
a first electrode assembly accommodating portion accommodating the first electrode assembly; and
a second electrode assembly accommodating portion accommodating the second electrode assembly,
wherein the first electrode assembly accommodating portion and the second electrode assembly accommodating portion are connected by the folded region.

13. The rechargeable battery as claimed in claim 12, wherein:
the bendable bent portion comprises:
first and second bent portions arranged in a zigzag shape; and
a third bent portion disposed between the first bent portion and the second bent portion,
wherein the third bent portion and the folded region are thermally compressed.

14. A rechargeable battery comprising:
a separator comprising a first bent portion, a second bent portion, a third bent portion disposed between the first bent portion and the second bent portion, a plurality of first separation portions connected to the first bent portion and the third bent portion, and a plurality of second separation portions connected to the second bent portion and the third bent portion,
wherein a first positive electrode and a first negative electrode of a first electrode assembly are separately disposed between the plurality of first separation portions,
a second positive electrode and a second negative electrode of a second electrode assembly are separately disposed between the plurality of second separation portions,
the first bent portion is connected to one side of the first separation portion and has a bent shape so that the first positive electrode or the first negative electrode is surrounded by the first separation portion,
the second bent portion is connected to one side of the second separation portion and has a bent shape so that the second positive electrode or the second negative electrode is surrounded by the second separation portion, and
the third bent portion is connected to the other side disposed opposite to the one side of the first separation portion and to the other side disposed opposite to the one side of the second separation portion.

15. A method of manufacturing a rechargeable battery, the method comprising:
alternately disposing a first electrode of each of different electrode assemblies in a matrix structure on one surface of a continuous sheet-shaped separator;
bending the continuous sheet-shaped separator in a direction of wrapping each first electrode to cover each first electrode with the continuous sheet-shaped separator;
alternately disposing a second electrode of each of the different assemblies at each first electrode on the other surface of the continuous sheet-shaped separator;
bending the continuous sheet-shaped separator in a direction covering each second electrode to cover each second electrode with the continuous sheet-shaped separator; and
pressing the continuous sheet-shaped separator so that the different electrode assemblies are stacked by bent portions formed between rows or columns of the matrix structure.
